(19) United States
(12) Patent Application Publication
(10) Pub. No.: US 2005/0234373 A1
(43) Pub. Date: Oct. 20, 2005

(54) Seat belt massager

(76) Inventor: Naila K. Khalaf, Los Angeles, CA (US)

Correspondence Address: RAYMOND Y. CHAN, 108 N. YNEZ AVE., SUITE 128, MONTEREY PARK, CA, 91754, US

(21) Appl. No.: 10/829,087

(22) Filed: Apr. 20, 2004

(51) Int. Cl. A61H 11/00

(52) U.S. Cl. 601/71; 601/143; 601/79

(57) ABSTRACT

A seat belt massager for detachably fastening on a seat belt, includes a massager body which has a message portion defining an inner treatment surface; a massaging device supported on the massage portion of the massager body and communicated with the treatment surface in such manner that the massaging device is adapted to deliver massage impulse to an exterior of the massager body through the treatment surface; and a seat belt fastening arrangement provided on the massager body for detachably fastening the massager body on the seat belt.

### BACKGROUND OF THE PRESENT INVENTION

1. Field of Invention

The present invention relates to a massaging device, and more particularly to a seat belt massager which is slidably attached on a seat belt to stimulate driver's blood circulation so as to effectively reduce driving fatigue and chronic abdomen pain.

2. Description of Related Arts

As many people experienced, long time driving resulted in fatigue. Sitting for a prolonged period of time in an immobile situation would definitely reduce driver's vigilance and concentration. However, keeping alert is crucial for driving, especially for those driving rapidly in freeways. Fatigued drivers have slower reaction time, thus putting themselves and other road users in danger should they encounter unusual, unexpected or emergency situations. Generally speaking, conversation and music can help stimulating the driver so as to keep him alert but they rarely have long-lasting effect. As a result, there exist some different massaging devices for use in facilitating driver's circulation for reducing fatigue.

A conventional massaging device may provide both heat and soothing massage. However, almost all of the massaging devices are adapted to be installed on a seat, such as a driver's seat in a car, so that they could only provide massaging stimulation to those areas contacting to the seat, such as driver's neck, back, at most legs. Admittedly, this sort of stimulation may increase the blood flow in those areas so as to reduce driving fatigue which leads to pain and muscle spasms in those areas, yet their applications are very limited in the sense that they lack the flexibility to cater different parts of the driver's body which may of course be a significant source of the driver's fatigue.

Nowadays, conventional massaging devices which are attached or installed on the driving seats usually provide variable intensity and speed control, different massaging modes, such as zigzag, wave, and impulses. Such massaging devices are often battery operated, but may also include adapters to be plugged into an external power source, such as an AC outlet.

Despite these, the disadvantage of limited and inflexible application still exists. For example, where the fatigue does not corn from the driver's back or neck, these conventional massaging devices are virtually useless. In fact, there is a body part in which fatigue or pain typically emerges but unfortunately they are often ignored by experts who are skilled in the art. For example, if a female driver suffers from menstrual abdomen pain, she may need a messaging device for reliving her pain, especially during driving. However, as a mater of fact, there exist few, if not none, massaging devices which are specifically designed and equipped for catering one's abdomen or chest pain.

As a result, the female driver may have to use a handhold massager or fasten a mini massager to their body for relieving her symptoms and pains, yet the handhold massager is inconvenient and dangerous in application, particularly during driving.

Apart from that, chest and abdomen massaging could speed up one's digestive process, promote elimination of waste, reduce excess abdominal fat, and improve blood circulation. Thus one may appreciate the importance and desirability of having such a abdomen and chest massaging.

In light of the above, a kind of massaging device, which is capable of being attached on the seat belt to provide stimulation to the chest or abdomen of a driver so as to relieve the fatigue symptoms and abdomen pains thereof, is reasonably required. This kind of seat belt massager is supposed to be conveniently and slidably attached on seat belt, so that a driver could selectively apply it on chest and abdomen areas while driving. And after the driver is out of the car, the seat belt is retracted so as to hold the massaging device in an insignificant position.

### SUMMARY OF THE PRESENT INVENTION

A main object of the present invention is to provide a seat belt massager, which is adapted to slidably and detachably attach on a seat belt for providing massage stimulation to the driver's abdomen or chest so as to relive possible fatigue or pain thereof.

Another object of the present invention is to provide a seat belt massager which is adapted to attach on a seat beat, and has a massaging surface which is arranged to communicate with the user's abdomen or chest when the seal belt is fastened on the user's body. In other words, the user of the present invention does not require to hold the massager by hands.

Another object of the present invention is to provide a seal belt massager which is light, and does not involve any complicated or expensive mechanical or electronic components, so as to maximize user's comfort and at the same time, minimize a selling price of the present invention.

Another object of the present invention is to provide a seat belt massager which is capable of being conveniently and easily attach to a typical seat beat so that the present invention fits for all seat belt and users of all ages.

Another object of the present invention is to provide a seat belt massager which is capable of being operated by batteries as well as an external AC power source so that the present invention is fit for use in a wide variety of vehicles.

Accordingly, in order to accomplish the above objects, the present invention provides a seat belt massager for detachably fastening on a seat belt, comprising:

a massager body which has a message portion defining an inner treatment surface;

a massaging device supported on said massage portion of said massager body and communicated with said treatment surface in such manner that said massaging device is adapted to deliver massage impulse to an exterior of said massager body through said treatment surface; and

a seat belt fastening arrangement provided on said massager body for detachably fastening said massager body on said seat belt.

These and other objectives, features, and advantages of the present invention will become apparent from the following detailed description, the accompanying drawings, and the appended claims.

### BRIEF DESCRIPTION OF THE DRAWINGS

FIG. 1 is a schematic view of a seat belt massager in application according to the first preferred embodiment of the present invention.

FIG. 2 is a perspective view of a seat belt massager according to the first preferred embodiment of the present invention.

FIG. 3 is a sectional view of a seat belt massager in application according to the first preferred embodiment of the present invention illustrating the massager attached a beat belt for providing the user impulse motion.

### DETAILED DESCRIPTION OF THE PREFERRED EMBODIMENT

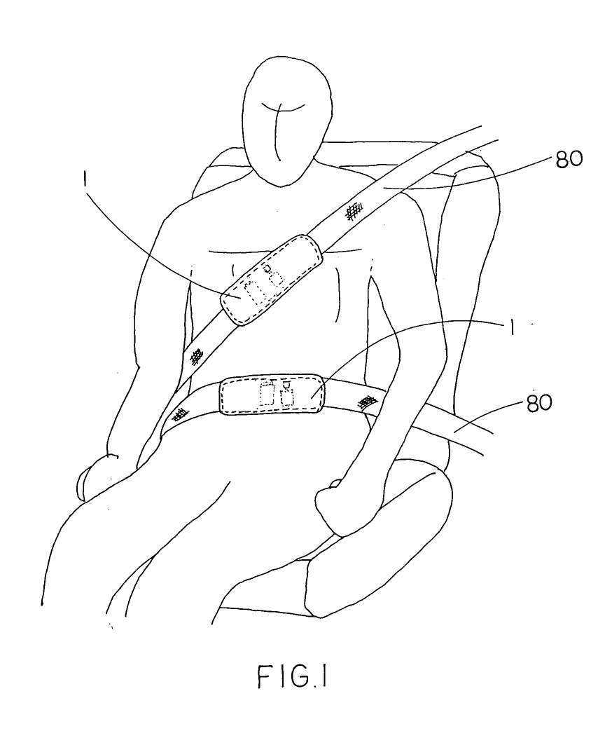

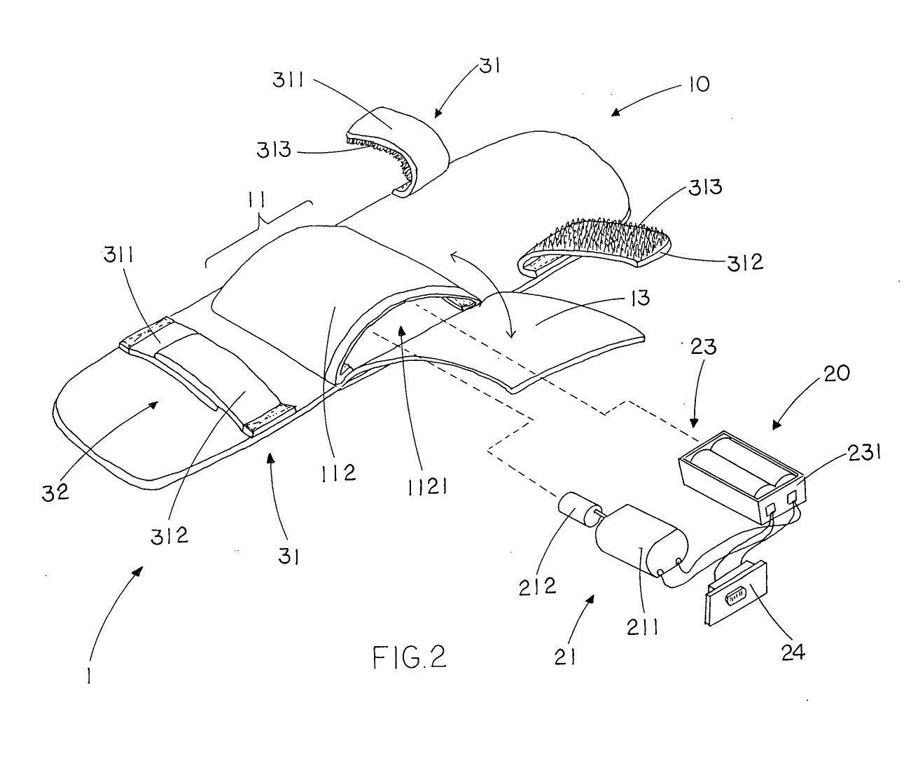

Referring to FIG. 1 to FIG. 2 of the drawings, a seat belt massager 1 for use on a seat belt 80 according to a preferred embodiment of the present invention is illustrated, in which the seat belt massager 1 comprises a massager body 10, a massaging device 20 supported by the massager body 10, and a seat belt fastening arrangement.

The massager body 10 is embodied as being fabricated by flexible materials, such as fabric materials, and has a central message portion 11 defining an inner treatment surface 111 adapted to rest on a user's body, and a receiving pocket 112 communicating with the treatment surface 111, wherein the massaging device 20 is disposed in the receiving pocket 112 for communicating with the treatment surface 111.

The massager device 20 is mounted on the massager body 10 in the receiving pocket 112, and adapted to deliver massage impulses to an exterior of the massager body 10 through the treatment surface 111 while the seat belt massager 1 is fastened on the seat belt 80. In other words, when a user is fastened with the seat belt 80, the massage impulse is adapted to be transmitted to the user through the treatment surface 111.

The seat belt fastening arrangement is provided on the massager body 10 for detachably fastening the seat belt massager 1 on the seat belt 80 while the inner treatment surface 111 is arranged to communicate with the user's body.

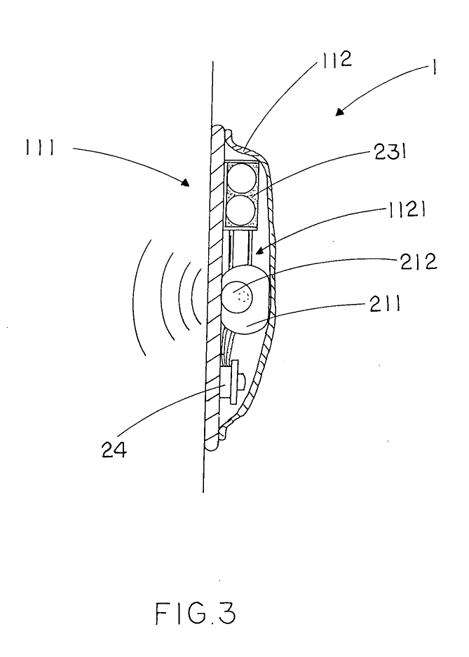

Referring to FIG. 2 to FIG. 3 of the drawings, the massager device 20 comprises a massage generating unit 21 comprising a driving motor 211 and a massage actuator 212 centrifugally mounted thereto in such a manner that it is adapted to be driven to rotate centrifugally so as to generate a massage impulse towards the treatment surface 111. In other words, the treatment surface 111 is subject to massage impulses generated by the centrifugal rotation of the massage actuator 212 so as to provide controlled vibrations for the treatment surface 111 in order to carry out the massage to the user of the present invention. Since the massager body 10 is preferably embodied as being fabricated from fabric materials, therefore, the massage impulses are capable of effectively and efficiently transmitting to the user through vibrations of the treatment surface 111.

The seat belt fastening arrangement comprises two seat belt fasteners 31 each of which comprises first and second elongated fastening straps 311, 312 frontwardly extended from the massager body 10 wherein two ends of the fastening straps 311, 312 are adjustably and overlappedly communicating with each other to define a connecting loop 32 within the two fastening straps 311, 312 in such a manner that the seat belt 80 is adapted to slidably pass through the connecting loop 32 so as to fasten with the massager body 10.

According to the preferred embodiment, each of the seat belt fasteners 31 further comprises means for adjustably and detachably connecting two of the respective fastening strap 311, 312 for defining the respective connecting loop 32 of each of the seat belt fasteners 31. The connecting means comprises a loop fastener 313 and hoop fastener 313 provided on two ends portions of the first and second fastening straps 311, 312 respectively which are adapted to adjustably and overlappedly fasten with each other so as to define the connecting loop 32 wherein the seat belt 80 is adapted to slidably passing therethrough. As a result, by adjusting a fastening position of the connecting means, the first and the second fastening straps 311, 312 of each of the seat belt fastener 31 is adapted to be adjustable so as to fit a wide variety of seat belts 80.

Moreover, since the seat belt fastener 31 is adapted to fasten the massager body 10 with the seat belt 80 in a slidably and detachably adjustable manner, therefore, the massager body 10 is adapted for sliding along the seat belt 80 so as to adjust a position of the treatment surface 111 to a desirable position along the seat belt 80 for delivering the massage impulses to an optimal position of the user's body. It is worth to mention that when the user is out of the vehicle, the seat belt massager 1 will automatically dispose in an insignificant position with the retracted seat belt 80, thus minimizing the hassle in dealing with the seat belt 80 while the user is not in the car.

Other conventional fastening means may be utilized to replace the above-mentioned fastening means. Typical example includes buttons, straps, buckles and the like.

Referring to FIG. 2 of the drawings, the massager device 20 further comprises a power supply 23 disposed in the receiving pocket 112 and electrically connected with the massage generating unit 21 of the massager device 20 for providing electrical power thereto. According to the preferred embodiment, the power supply 23 comprises a battery holder 231 securely supported in the receiving pocket 112 wherein at least one battery, such as a typical AAA battery, is disposed in the battery holder 231 as a power source for the provision of the electrical power.

Alternatively, the power supply 23 may be embodied as a plurality of electrical wires extended from the massager body 10 to an external power source, such as a regular Alternate Current (AC) or Direct Current (DC) power source which is conventionally provided in a vehicle. Yet another alternative is that the user of the present invention may selectively choose which power supply is to be utilized for differing surrounding circumstances.

The massager device 20 further comprises a control switch 24 electrically connected between the power supply 23 and the massage generating unit 21 for switching the massage generating unit 21 in an on or off state. Specifically, the control switch 24 is disposed in the receiving pocket 112 which defines an access opening 1121 communicating the receiving pocket 112 with an exterior of the massager body 10 wherein the user of the present invention may be able to operate the control switch 24 through the access opening 1121.

The control switch 24 may be selectively switch at a predetermined level so that the massage generating unit 21 is adapted to deliver the massaging impulse at a predetermined intensity among a range of discrete or continuous intensities for different usages. Accordingly, the control switch 24 may be embodied as a switch button which is adapted to switch among a plurality of operation levels so as to select different intensity for the massaging impulse.

According to the preferred embodiment, the massager body 10 further comprises a flipping cover 13 movably provided thereon for movably and overlappedly covering the receiving pocket 112. Specifically, the flipping cover 13 is fabricated by fabric materials which is stitched onto the massager body 10 for normally covering the receiving pocket 112 so as to hide the massager device 20 from being directly exposed to an exterior of the massager body 10. In other words, the user of the present invention may be able to easily and conveniently flip over the flipping cover 13 so as to access the massager device 20 via the access opening 1121.

In order to further enhance the comfort provided by the present invention, the massager body 10 may further comprises a cushion layer 14 attached on a rear side of the massager body 10 for providing a cushioning effect to the user of the present invention. The cushion layer 14 is preferably made of pliable or spongy materials for evenly distributing the massaging impulse from the massage generating unit 21 to the user's body via the treatment surface 111.

In light of the above, one may reasonably appreciate that massaging impulse of the present invention could soothe muscles as well as skin tissue thereby substantially improving the circulation of the user, and generating frictional heat to relieve the user pain, such as female menstrual pain during driving.

One skilled in the art will understand that the embodiment of the present invention as shown in the drawings and described above is exemplary only and not intended to be limiting.

It will thus be seen that the objects of the present invention have been fully and effectively accomplished. It embodiments have been shown and described for the purposes of illustrating the functional and structural principles of the present invention and is subject to change without departure form such principles. Therefore, this invention includes all modifications encompassed within the spirit and scope of the following claims.

1. A seat belt massager for detachably fastening on a seat belt, comprising:
a massager body which has a message portion defining an inner treatment surface;
a massaging device supported on said massage portion of said massager body and communicated with said treatment surface in such manner that said massaging device is adapted to deliver massage impulse to an exterior of said massager body through said treatment surface; and
a seat belt fastening arrangement provided on said massager body for detachably fastening said massager body on said seat belt.

2. The seat belt massager, as recited in claim 1, wherein said massager body further has a receiving pocket formed on said massage portion, and defining an access opening which communicates said receiving pocket with an exterior of said massage body wherein said massaging device is disposed in said receiving pocket via said access opening.

3. The seat belt massager, as recited in claim 2, wherein said massager device comprises a massage generating unit comprising a driving motor and a massage actuator centrifugally mounted thereto in such a manner that said massage actuator is adapted to be driven to rotate centrifugally by said driving motor so as to generate a massage impulse towards said treatment surface which communicates with a user's body.

4. The seat belt massager, as recited in claim 3, wherein said seat belt fastening arrangement comprises at least one seat belt fastener comprising first and second elongated fastening straps frontwardly extended from said massager body wherein two end portions of said fastening straps are adjustably and overlappedly communicating with each other to define a connecting loop within said two fastening straps and said massager body, such that said seat belt is adapted to slidably pass through said connecting loop so as to fasten with said massager body.

5. The seat belt massager, as recited in claim 4, wherein said seat belt fastener comprises means for adjustably and detachably connecting said two end portions of said two fastening straps in said overlappedly communicating manner for defining said respective connecting loop of said seat belt fastener.

6. The seat belt massager, as recited in claim 5, wherein said connecting means of said seat belt fastener comprises a loop fastener and a hoop fastener affixed on said two ends portions of said two fastening straps respectively, and are adapted to overlappedly, adjustably and detachably fasten with each other so as to define said connecting loop for said seat belt passing therethrough.

7. The seat belt massager, as recited in claim 5, wherein said massager device further comprises a power supply disposed in said receiving pocket and electrically connected with said massage generating unit of said massage device for providing electrical power thereto, wherein said power supply comprises a battery holder securely mounted in said receiving pocket for receiving at least one battery therein for providing said electrical power.

8. The seat belt massager, as recited in claim 6, wherein said massager device further comprises a power supply disposed in said receiving pocket and electrically connected with said massage generating unit of said massage device for providing electrical power thereto, wherein said power supply comprises a battery holder securely mounted in said receiving pocket for receiving at least one battery therein for providing said electrical power

9. The seat belt massager, as recited in claim 3, wherein said massager device further comprises a control switch electrically connected between said power supply and said message generating unit for switching said massage generating unit to operate at a predetermined level, and is arranged to be access by a user through said access opening

10. The seat belt massager, as recited in claim 7, wherein said massager device further comprises a control switch electrically connected between said power supply and said message generating unit for switching said massage generating unit to operate at a predetermined level, and is arranged to be access by a user through said access opening.

11. The seat belt massager, as recited in claim 8, wherein said massager device further comprises a control switch electrically connected between said power supply and said message generating unit for switching said massage generating unit to operate at a predetermined level, and is arranged to be access by a user through said access opening.

12. The seat belt massager, as recited in claim 9, wherein said massager body further comprises a flipping cover movably provided thereon for normally and overlappedly covering said receiving pocket so as to hide said massager device from being directly exposed to an exterior of said massager body.

13. The seat belt massager, as recited in claim 10, wherein said massager body further comprises a flipping cover movably provided thereon for normally and overlappedly covering said receiving pocket so as to hide said massager device from being directly exposed to an exterior of said massager body.

14. The seat belt massager, as recited in claim 11, wherein said massager body further comprises a flipping cover movably provided thereon for normally and overlappedly covering said receiving pocket so as to hide said massager device from being directly exposed to an exterior of said massager body.

15. The seat belt massager, as recited in claim 12, wherein said massager body further comprises a cushion layer which is made of pliable materials, attached on a rear side of said massager body for providing a cushioning effect thereof.

16. The seat belt massager, as recited in claim 13, wherein said massager body further comprises a cushion layer, which is made of pliable materials, attached on a rear side of said massager body for providing a cushioning effect thereof.

17. The seat belt massager, as recited in claim 14, wherein said massager body further comprises a cushion layer, which is made of pliable materials, attached on a rear side of said massager body for providing a cushioning effect thereof.

18. The seat belt massager, as recited in claim 15, wherein said massager body is fabricated by fabric materials which is sufficiently flexible for effectively transmitting said massaging impulse from said massage generating unit to said user via said treatment surface while maximizing a comfort of said seat belt massager to said user.

19. The seat belt massager, as recited in claim 16, wherein said massager body is fabricated by fabric materials which is sufficiently flexible for effectively transmitting said massaging impulse from said massage generating unit to said user via said treatment surface while maximizing a comfort of said seat belt massager to said user.

20. The seat belt massager, as recited in claim 17, wherein said massager body is fabricated by fabric materials which is sufficiently flexible for effectively transmitting said massaging impulse from said massage generating unit to said user via said treatment surface while maximizing a comfort of said seat belt massager to said user.
